(19) United States
(12) Patent Application Publication
(10) Pub. No.: US 2012/0316817 A1
(43) Pub. Date: Dec. 13, 2012

(54) MEASUREMENT CIRCUIT FOR MEASURING DIRECT CURRENT RESISTANCE OF INDUCTOR

(75) Inventors: SONG-LIN TONG, Shenzhen City (CN); QI-YAN LUO, Shenzhen City (CN); PENG CHEN, Shenzhen City (CN); FU-SEN YANG, Shenzhen City (CN); YUN BAI, Shenzhen City (CN)

(73) Assignees: HON HAI PRECISION INDUSTRY CO., LTD., New Taipei (TW); HONG FU JIN PRECISION INDUSTRY (ShenZhen) CO., LTD, Shenzhen City (CN)

(21) Appl. No.: 13/181,524

(22) Filed: Jul. 13, 2011

(30) Foreign Application Priority Data
Jun. 8, 2011 (CN) 201110152245.2

(51) Int. Cl. G06F 19/00

(52) U.S. Cl. 702/65

(57) ABSTRACT

A circuit for measuring the DC resistance of an inductor includes an input unit, a microprocessor module, a current source and a voltage detecting unit. The microprocessor module receives signals from the input unit and generates different signals to command constant currents through the inductor by the current source. The voltage detecting unit reads voltages of the inductor and outputs the voltages obtained to the microprocessor module. According to the currents and the voltages read, the microprocessor module may calculate the DC resistance(s) of the inductor.

### 1. TECHNICAL FIELD

The disclosure generally relates to a measurement circuit, and particularly to a circuit for measuring the direct current resistance of an inductor.

### 2. DESCRIPTION OF RELATED ART

At present, inductors are widely used as filters and are indispensable for energy storage purposes. During any testing of electronic devices, a direct current (DC) resistance of the inductors should be measured, wherein the DC resistance represents the DC component of the impedance of the inductors. However, the DC resistance of the inductor is generally very small and cannot be measured accurately by an ohmmeter. In addition, the inductors have to be removed from the electronic devices for testing and may not be reused, this is not efficient or expedient.

Therefore, there is room for improvement in the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block view for a measurement circuit for measuring the DC resistance of inductors in accordance with an embodiment.

FIG. 2 is an illustrative view of a processor module in FIG. 1.

FIG. 3 is an illustrative view of a voltage detecting unit in FIG. 1.

### DETAILED DESCRIPTION

An embodiment of the present disclosure will now be described in detail and with reference to the drawings.

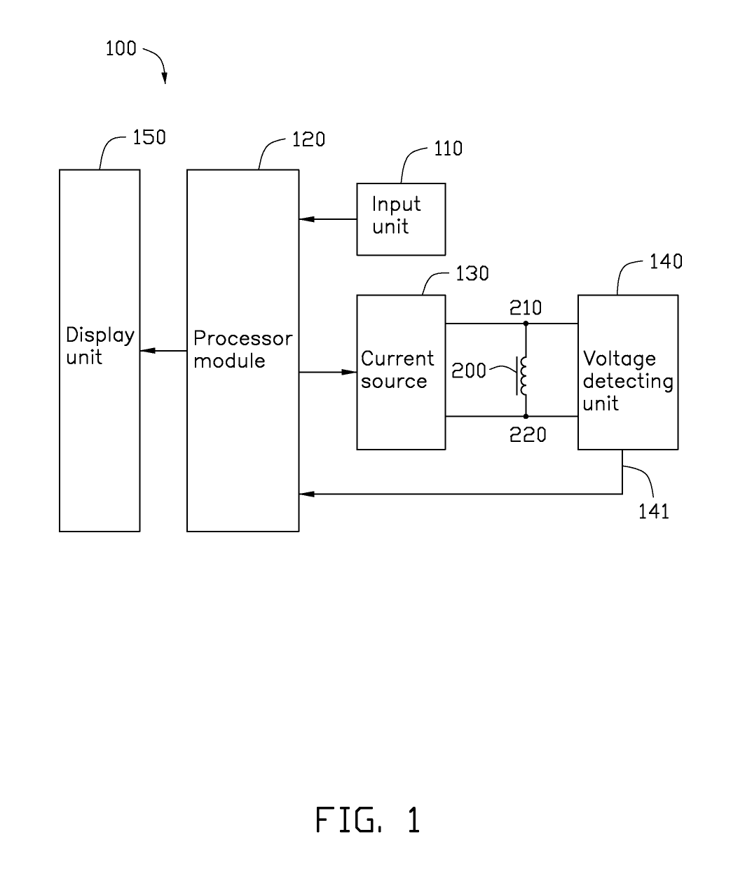

Referring to FIG. 1, a circuit for measuring (measurement circuit 100) the DC resistance of inductors according to an embodiment is shown. The measuring circuit 100 includes an input unit 110, a processor module 120, a current source 130, a voltage detecting unit 140 and a display unit 150. The input unit 110 provides signals to the processor module 120. The processor module 120 controls the current source 130 to apply a constant current to an inductor 200 according to the signals. The inductor 200 includes a first terminal 210 and a second terminal 220. The voltage detecting unit 140 is connected between the first terminal 210 and the second terminal 220 to read a voltage of the inductor 200. The voltage detecting unit 140 includes an output terminal 141 to transmit the voltage of the inductor 200 to the processor module 120. According to the current of the inductor 200 and the corresponding voltage, the processor module 120 can calculate the DC resistance of the inductor 200. The display unit 150 is configured to show the value of the current of the inductor 200 and the corresponding DC resistance.

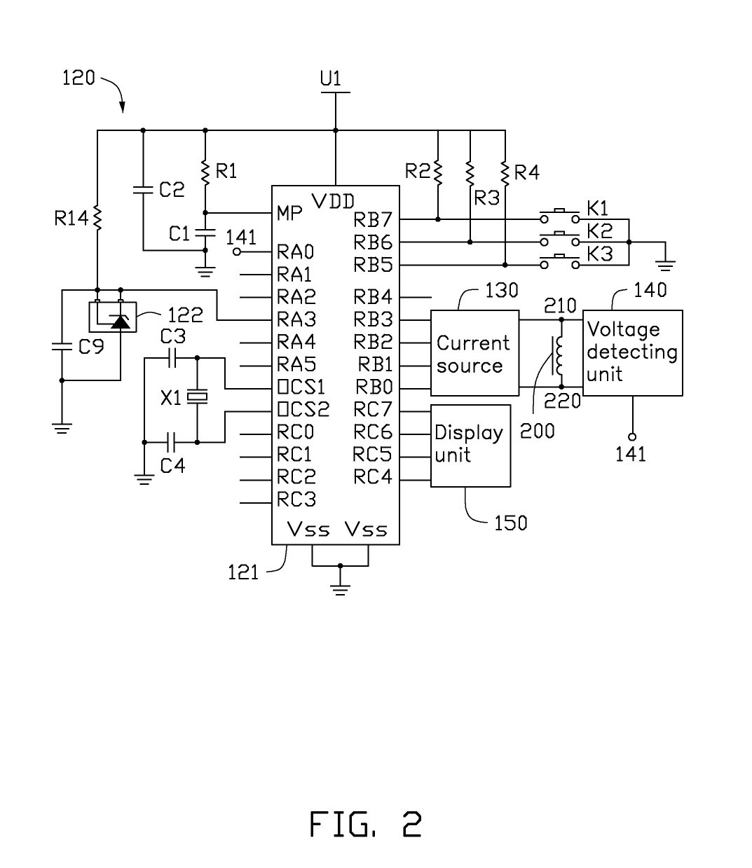

Referring also to FIG. 2, the processor module 120 includes a microprocessor chip 121, a first resistor R1, first to fourth capacitors C1-C4 and a crystal oscillator X1. A first voltage pin VDD of the microprocessor chip 121 is connected to a first power source U1 and connected to ground through the first resistor R1 and the first capacitor C1 which are connected in series. A second voltage pin MP of the microprocessor chip 121 is connected between the first resistor R1 and the first capacitor C1. The second capacitor C2 is connected between the first power source U1 and ground. A first clock pin OCS1 of the microprocessor chip 121 is connected to ground through the third capacitor C3 and a second clock pin OCS2 of the microprocessor chip 121 is connected to ground through the fourth capacitor C4. The crystal oscillator X1 is connected between the first clock pin OCS1 and the second clock pin OCS2. Output pins RB0-RB3 of the microprocessor chip 121 are connected to the current source 130 and output pins RC6-RC7 are connected to the display unit 150. In this embodiment, the microprocessor chip 121 is a PIC16C72. The current source 130 is capable of being programmed.

The input unit 110 includes a plurality of keys, which can be selectively pressed to output different signals. In this embodiment, the input unit 110 includes first to third keys K1-K3 and second to fourth resistors R2-R4. The first terminals of the keys K1-K3 are connected to input pins RB5-RB7 of the microprocessor chip 121, and the second terminals of the K1-K3 are connected to ground. In addition, the first terminals of the keys K1-K3 are connected to the first power source U1 through the second to fourth resistors R2-R4 respectively. By pressing the keys K1-K3, the microprocessor chip 121 outputs different control signals to the current source 130. The current source 130 applies a variety of currents to the inductor 200 according to the different control signals generated by the microprocessor chip 121.

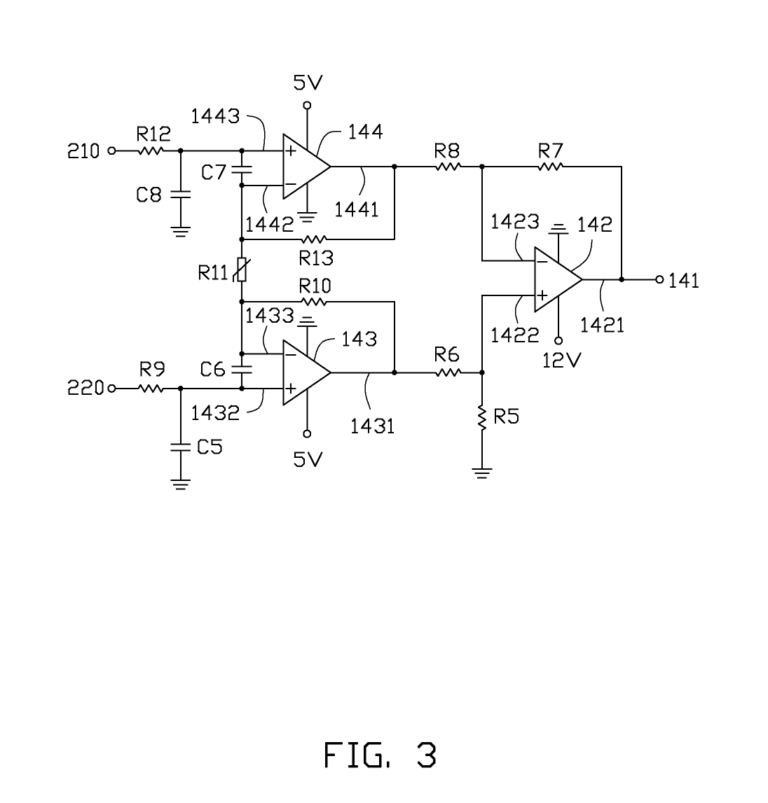

Referring to FIG. 3, the voltage detecting unit 140 is a differential amplification circuit for amplifying the voltage of the inductor 200 and transmitting it to the processor module 120. The differential amplification circuit includes first to third amplifiers 142-144, fifth to thirteenth resistors R5-R13 and fifth to eighth capacitors C5-C8. An output terminal 1421 of the first amplifier 142 is connected to an input pin RA0 of the microprocessor chip 121. A non-inverting input terminal 1422 of the first amplifier 142 is connected to ground through the fifth resistor R5, and connected to an output terminal 1431 of the second amplifier 143 through the sixth resistor R6. An inverting input terminal 1423 of the first amplifier 142 is connected to the output terminal 1421 of the first amplifier 142 through the seventh resistor R7, and connected to an output terminal 1441 of the third amplifier 144 through the eighth resistor R8. A non-inverting input terminal 1432 of the second amplifier 143 is connected to ground through the fifth capacitor R5 and connected to the second terminal 220 of the inductor 200 through the ninth resistor R9. An inverting input terminal 1433 of the second amplifier 143 is connected to the output terminal 1431 of the second amplifier 143 through the tenth resistor R10 and connected to a reverse-phase 1442 of the third amplifier 144 through the eleventh resistor R11. The sixth capacitor C6 is connected between the in-phase input terminal 1432 and the reverse-phase input terminal 1433 of the second amplifier 143. A non-inverting input terminal 1442 of the third amplifier 144 is coupled to ground through the twelfth resistor R12 and connected to the first terminal 210 of the inductor 200. An inverting input terminal 1443 of the third amplifier 144 is coupled to the output terminal 1441 of the third amplifier 144. The eighth capacitor C8 is connected between the in-phase input terminal 1442 and the reverse-phase input terminal 1443 of the third amplifier 144. In the differential amplification circuit described above, the resistances of the fifth resistor R5 and the seventh resistor R7 are 51KΩ; the resistances of the sixth resistor R6, the eighth resistor R8, the ninth resistor R9 and the twelfth resistor R12 are 1KΩ; the resistances of the tenth resistor R10 and the thirteenth resistor R13 are 20KΩ; the resistance of the eleventh resistor R11 is 470KΩ. The capacitances of the fifth capacitor C5 and the seventh capacitor C7 are 0.1 μF; and the capacitances of the sixth capacitor C6 and the eighth capacitor C8 are 100 pF. A voltage input terminal of the first amplifier 142 is connected to a 12V power source, and the voltage input terminals of the second amplifier 143 and the third amplifier 144 are connected to a 5V power source. The above differential amplification circuit can effectively amplify the voltage of the inductor 200 and resist noise-interference.

In this embodiment, an input terminal RA2 of the microprocessor chip 121 is connected to a reference power source. The reference power source includes a three-terminal adjustable shunt regulator 122, a ninth capacitor C9 and a fourteenth resistor R14. A cathode and a control node of the three-terminal adjustable shunt regulator 122 is connected to an input terminal RA2 of the microprocessor chip 121, and an anode of the three-terminal adjustable shunt regulator 122 is connected to ground. The ninth capacitor C9 is connected between the input terminal RA2 and ground, and the fourteenth resistor R14 is connected between the input terminal RA2 and the first power source U1. Therefore, the reference power source can provide a reference voltage of approximately 2.5V to the microprocessor chip 121. The three-terminal adjustable shunt regulator 122 can be a TL431.

In the measurement circuit 200 described above, the current source 130 provides constant currents to the inductor 200. Therefore, it is not necessary to remove the inductor 200 from an electric product to test its DC resistance. In addition, while using the measurement circuit 200, users can input signals to the processor module 120 through the input unit 110. The signals represent different values of the current applied to the inductor 200, such as 2 A, 4 A, 6 A, 8 A, 10 A, 12 A, 14 A, 16 A, 18 A and 20 A, and the processor module 120 controls the current source 130 to provide these currents to the inductor 200. The corresponding voltages of the inductor 200 can be read by the voltage detecting unit 140 and the DC resistance(s) can be calculated.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A measurement circuit for measuring a DC resistance of an inductor, comprising:
an input unit, comprising a plurality of keys, which can be pressed down to output different signals;
a microprocessor module, receiving the signals from the input unit and generating different control signals according to the signals;
a current source, providing constant currents to the inductor according to the control signals; and
a voltage detecting unit, obtaining voltages of the inductor and output the voltages to the microprocessor module, the microprocessor module calculating the DC resistances of the inductor according to the currents and the corresponding voltages.

2. The measurement circuit of claim 1, further comprising a display unit to display the currents inputted by the input unit and the corresponding DC resistances of the inductor.

3. The measurement circuit of claim 1, wherein the processor module comprises a microprocessor chip, a first resistor, first to fourth capacitors and a crystal oscillator, a first voltage pin of the microprocessor chip is connected to a first power source and connected to ground through the first resistor and the first capacitor connected in series, a second voltage pin of the microprocessor chip is connected between the first resistor and the first capacitor, the second capacitor is connected between the first power source and ground, a first clock pin of the microprocessor chip is connected to ground through the third capacitor and a second clock pin of the microprocessor chip is connected to ground through the fourth capacitor, and the crystal oscillator is connected between the first clock pin and the second clock pin.

4. The measurement circuit of claim 3, wherein the keys comprises first to third keys, first terminals of the first to third keys are connected to three different input pins of the microprocessor chip, and second terminals of the first to third keys are connected to ground.

5. The measurement circuit of claim 3, wherein the first terminals of the first to third keys are connected to a first power source through second to fourth resistors.

6. The measurement circuit of claim 1, wherein the voltage detecting unit is a differential amplification circuit for amplifying the voltage of the inductor and transmitting it to the processor module.

7. The measurement circuit of claim 6, wherein the differential amplification circuit comprises first to third amplifiers, fifth to thirteenth and fifth to eighth capacitors, an output terminal of the first amplifier is connected to an input pin of the microprocessor chip, a non-inverting input terminal of the first amplifier is connected to ground through the fifth resistor, and connected to an output terminal of the second amplifier through the sixth resistor, an reverse-phase input terminal of the first amplifier is connected to the output terminal of the first amplifier through the seventh resistor, and connected to an output terminal of the third amplifier through the eighth resistor, a non-inverting input terminal of the second amplifier is connected to ground through the fifth capacitor and connected to the second terminal of the inductor through the ninth resistor, an inverting input terminal of the second amplifier is connected to the output terminal of the second amplifier through the tenth resistor and connected to a reverse-phase of the third amplifier through the eleventh resistor, the sixth capacitor is connected between the in-phase input terminal and the reverse-phase input terminal of the second amplifier, a non-inverting input terminal of the third amplifier is coupled to ground through the twelfth resistor and connected to the first terminal of the inductor, an inverting input terminal of the third amplifier is coupled to the output terminal of the third amplifier, and the eighth capacitor is connected between the in-phase input terminal and the reverse-phase input terminal of the third amplifier.

8. The measurement circuit of claim 3, further comprising a reference power source, the reference power source connecting to an input pin of the microprocessor chip and providing a reference voltage to the microprocessor chip.

9. The measurement circuit of claim 8, wherein the reference power source comprises a three-terminal adjustable shunt regulator, a ninth capacitor and a fourteenth resistor, a cathode and a control node of the three-terminal adjustable shunt regulator is connected to an input terminal of the microprocessor chip, an anode of the three-terminal adjustable shunt regulator is connected to ground, the ninth capacitor is connected between the input terminal and ground, and the fourteenth resistor is connected between the input terminal and the first power source.
